(19) United States
(12) Patent Application Publication
(10) Pub. No.: US 2005/0144339 A1
(43) Pub. Date: Jun. 30, 2005

(54) Speculative processing of transaction layer packets

(76) Inventors: Mahesh U. Wagh, Tacoma, WA (US); Buck W. Gremel, Olympia, WA (US); Naveen Bohra, Tacoma, WA (US)

Correspondence Address: CARRIE A. BOONE, P.C., 2450 LOUISIANA, SUITE 400-310, HOUSTON, TX, 77006, US

(21) Appl. No.: 10/746,481

(22) Filed: Dec. 24, 2003

(51) Int. Cl. G06F 3/00

(52) U.S. Cl. 710/36

(57) ABSTRACT

A receiving device in which transaction layer packets are speculatively forwarded, is disclosed. The receiving device includes a physical layer, a link layer, a transaction layer, and a core. Transaction layer packets are forwarded to the transaction layer before processing at the link layer is completed, and without the use of memory storage at the link layer. A link layer engine checks the sequence number only and not the CRC before forwarding the packet to the transaction layer. This allows the transaction layer to pre-process the packet, such as verifying header information. However, the transaction layer is unable to make the transaction globally available until the link layer has verified the CRC of the packet. The simultaneous processing of the packet by both the link layer and the transaction layer may reduce latency and lessens the amount of memory needed for processing.

### FIELD OF THE INVENTION

This invention relates to a protocol for communication between devices and, more particularly, to the processing of transaction layer packets between a requesting device and a receiving device.

### BACKGROUND OF THE INVENTION

Communication protocols, of which there are many, enable different types of connected devices to converse. PCI Express, for example, is a serial input/output (I/O) protocol in which devices, such as chips or adapter cards, communicate with one another using packets.

PCI Express employs a scalable serial interface. Two low-voltage, differential driven signal pairs, one for transmit, one for receive, constitute a PCI Express link between two devices. (The PCI Express™ Base Specification, Revision 1.0a, was published by the PCI Special Interest Group, www.pcisig.com, on Apr. 15, 2003.)

The PCI Express protocol defines a transmission layer, a link layer, and a physical layer, present in both a transmit device and a receive device, the devices being connected by a PCI Express link. At the transmit device, the transmission layer assembles packets of transaction requests, such as reads and writes, from the device core. Header information is added to the transaction request, to produce transaction layer packets (TLPs). The link layer of the transmitting device applies a data protection code, such as a cyclic redundancy check (CRC), and assigns a sequence number to each TLP. At the physical layer, the TLP is framed and converted to a serialized format, then is transmitted across the link at a frequency and width compatible with the receiving device.

At the receiving device, the process is reversed. The physical layer converts the serialized data back into packet form, and stores the extracted TLP in memory at the link layer. The link layer verifies the integrity of the received TLP, such as by performing a CRC check of the packet, and also confirms the sequence number of the packet. Once both checks are performed, the TLP, excluding the sequence number and the link layer CRC, is forwarded to the transaction layer. The transaction layer disassembles the packet into information (e.g., read or write requests) that is deliverable to the device core. The transaction layer also detects unsupported TLPs and may perform its own data integrity check. If the packet transmission fails, the link layer requests retransmission of the TLP, known as a link layer retry (LLR).

While effective, the division of labor between the various layers in the communication link may produce undesirable latency in processing the transaction. The latency on a link depends on many factors, including pipeline delays, width and operational frequency of the link, and electrical transmission delays. The communications protocol itself may also produce an undesirable latency.

For example, link layer processing is completed in its entirety before a packet is transferred to the transaction layer. Put another way, the transaction layer is unable to begin processing the packet until the link layer is done processing the packet. This method ensures that transactions are not forwarded to the core unless validated by the link layer. However, the scheme also causes some latency in the processing of the packet.

As another example, at the receiving device, the TLP is stored at the link layer and again stored at the transaction layer. Link layer processing of the TLP occurs in link layer memory before being sent to the transaction layer. Likewise, transaction layer processing of the TLP occurs in transaction layer memory before being sent to the device core. By completing the processing of the TLPs in each layer, both the link layer and the transaction layer must separately provide memory space for the transaction.

Thus, there is a continuing need for a communications protocol that overcomes the shortcomings of the prior art.

### BRIEF DESCRIPTION OF THE DRAWINGS

FIG. 1 is a block diagram of a system with two devices connected together by a communications link, according to the prior art;

FIG. 2 is a block diagram of the system of FIG. 1, in which the transactions of the link layer and the transaction layer are detailed, according to the prior art;

FIG. 3 is a flow diagram depicting operation of the link and transaction layers in the system of FIG. 1, according to the prior art;

FIG. 4 is a block diagram of a system in which speculative pipeline processing of packets is performed, according to some embodiments;

FIG. 5 is a table showing how the system of FIG. 3 processes incorrectly numbered packets, according to some embodiments; and

FIG. 6 is a flow diagram depicting operation of the link and transaction layers in the system of FIG. 4, according to some embodiments.

### DETAILED DESCRIPTION

In accordance with the embodiments described herein, a receiving device including a physical layer, a link layer, a transaction layer, and a core, is disclosed in which transaction layer packets are speculatively forwarded from the link layer to the transaction layer before processing at the link layer is completed, and without the use of memory storage at the link layer. A link layer engine minimally processes the data link layer packet by checking the sequence number only and not the CRC before forwarding the packet to the transaction layer. This allows the transaction layer to pre-process the packet, such as verifying header information. However, the transaction layer is unable to make the transaction globally available until the link layer has verified the CRC of the packet. The simultaneous processing of the packet by both the link layer and the transaction layer reduces latency, in some embodiments, and lessens the amount of memory needed for processing.

In the following detailed description, reference is made to the accompanying drawings, which show by way of illustration specific embodiments other embodiments will become apparent to those of ordinary skill in the art upon reading this disclosure. The following detailed description is, therefore, not to be construed in a limiting sense, as the scope of the present invention is defined by the claims.

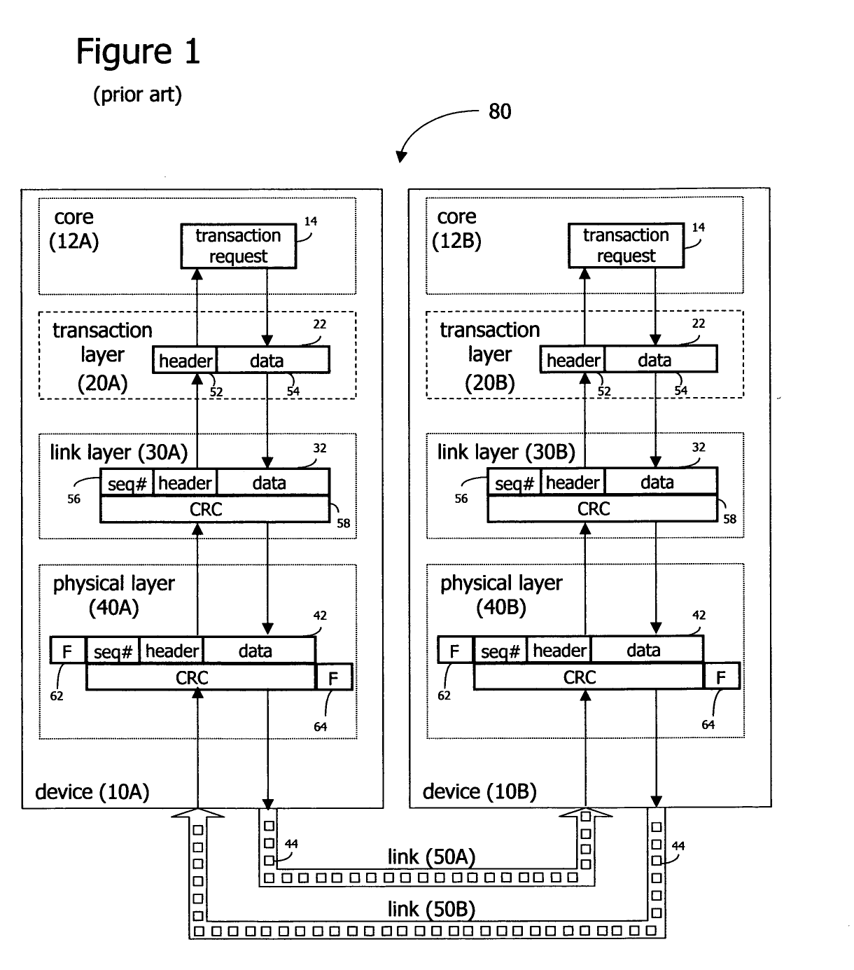

In FIG. 1, according to the prior art, a system 80 including devices 10A and 10B (collectively, devices 10) is shown. The system 80 employs a communications protocol for sending and receiving transaction requests between the devices 10. In some embodiments, the communications protocol is the PCI Express protocol, described above. Although the devices 10 appear in FIG. 1 to be in close proximity to one another, they may be remote devices within a single computer system, or may each be located on two distinct systems, in which each system is remote from one another. The two systems may be connected together in the same room or may be hundreds of miles apart from one another.

Two low-voltage, differential driven signal pairs, or links 50A and 50B (collectively, links 50) establish a conduit between the devices 10, through which the devices may communicate. The link 50A processes transactions that are sent from the device 10A (as transmitter) to the device 10B (as receiver). Likewise, the link 50B processes transactions that are sent from the device 10B (as transmitter) to the device 10A (as receiver).

Each device consists of distinct functional layers for processing transactions. The device 10A includes a core 12A, a transaction layer 20A, a link layer 30A, and a physical layer 40A. The device 10B includes a core 12B, a transaction layer 20B, a link layer 30B, and a physical layer 40B. Transaction request 14A originates from the core 12A of the device 10A while transaction request 14B originates from the core 12B of the device 10B (collectively, transaction requests 14). Either device may be a transmitter or a receiver, depending on the direction of communication. Further, both devices 10A and 10B are involved in the processing of either the transaction request 14A or the transaction request 14B.

Arrows in FIG. 1 indicate the flow of processing. A transaction request 14 originating at the core 12A of the device 10A (i.e., the transmitting device) is sent to the transaction layer 20A, where a data structure 22, known as a transaction layer packet (TLP), is produced. Transaction requests may be of different types, such as memory reads or writes, I/O reads or writes, configuration transactions, and message requests. The transaction request 14 may be a memory read request, for example. The TLP 22 includes a header 52 and a data field 54.

The header 52, which appears at the beginning of the TLP 22, is a set of fields that includes information about the transaction request 14, such as the purpose of the transaction and other characteristics. In some embodiments, the header 52, is twelve to sixteen bytes in length, and includes such information as the transaction type, the transaction length, and the identification (ID) of the requesting device. The data field 54 includes any data involved in the transaction. (For a write transaction, the data field 54 includes the data to be written, as one example.) For transactions that involve no data, the data field is of length zero. Once the TLP 22 is assembled at the transaction layer 20A, the TLP 22 is passed to the link layer 30A within the device 10A.

At the link layer 30A, a new transaction layer packet (TLP) 32 is constructed by adding fields to the TLP 22. The link layer 30A is an intermediate stage between the transaction layer 20A and the physical layer 40A. To ensure that the packets are reliably transmitted to the receiving device 10B, the link layer 30A assigns a sequence number 56 to each TLP. In FIG. 1, the sequence number 56 is added to the beginning of the TLP 32. The link layer 30A also calculates a data protection code, such as a CRC 58, and adds the CRC 58 to the TLP 32. Once the sequence number 56 and CRC 58 are added, the TLP 32 is passed to the physical layer 40A within the device 10A.

The physical layer 40A takes the TLP 32 and prepares it for serial transmission over the link 50A. A frame 62 is added to the beginning of the TLP and a second frame 64 is added to the end of the TLP, resulting in packet 42. The packet 42 is then transmitted, one bit 44 at a time, over the link 50A, to be received by the device 10B (i.e., the receiving device).

At the receiving device 10B, a reverse process transforms the packet back into a form that can be processed by the core 12B. The serialized stream of bits 44 received by the device 10B is assembled into a packet 42 in the physical layer 40B, where it is stripped of the frames 62 and 64 and sent to the link layer 30B as TLP 32 (which includes the TLP 22). The link layer 30B confirms the sequence number 56 and calculates the CRC 58. If one or both indicators are erroneous, the link layer 30B requests retransmission of the transaction request 14, by sending a link level retry (LLR) signal to the transmitting device 10A (going through the link 50B). If the sequence number 56 and CRC 58 are correct, the link layer sends the TLP 22 (minus the sequence number and CRC) to the transaction layer 20B.

Once the TLP 22 has reached the transaction layer 20B, the packet has already passed data integrity checks at the link layer. However, the transaction layer 20B checks several fields of the header 52 to ensure proper processing of the TLP 22, before sending it on to the core 12B. Finally, the transaction layer 20B submits the transaction request 14 to the core 12B. Thus, the transaction request 14 that started at the core 12A of the device 10A is successfully received by the core 12B of the device 10B.

Transaction requests 14 submitted by the device 10B are similarly processed. If, for example, the transaction request 14 from the device 10A is one in which a response is expected, the core 12B of the device 10B will issue a transaction request in the other direction, back to the device 10A. In any event, a transaction request 14 initiated by the core 12B becomes a TLP 22 at the transaction layer 20B, a TLP 32 at the link layer 30B, and a serially transmitted packet 42 at the physical layer 40B. Serialized bits 44 traverse the link 50B, to be received by the device 10A, and assembled into packet 42 in the physical layer 40A. There, the frames 62 and 64 are stripped off, the TLP 32 is sent to the link layer 30A, where the sequence number 56 and CRC 58 are verified, then the header 52 and data 54 portions (i.e., the TLP 22) are sent to the transaction layer 20A. The transaction layer 20A processes the header (and transaction layer CRC, if present), and submits the transaction request 14 to the core 12A of the receiving device 10A.

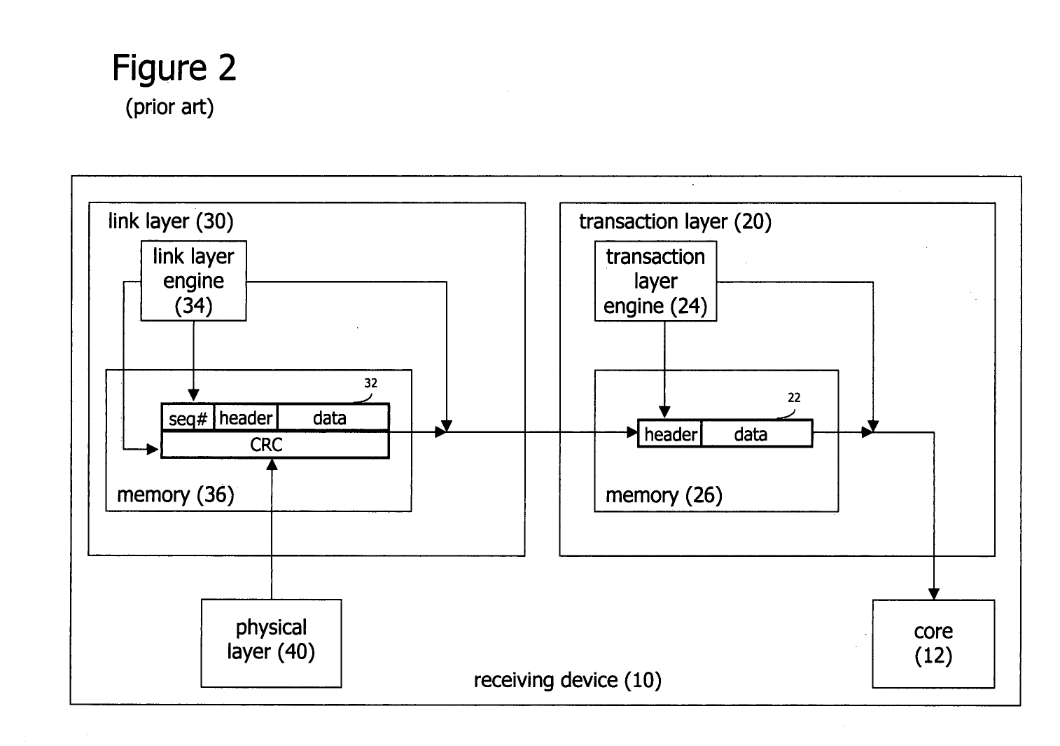

In FIG. 2, the operations of the link layer 30 and the transaction layer 20 of a prior art receiving device 10 are illustrated. The link layer 30 includes a link layer engine 34, for processing the incoming TLP 32, and a memory 36 for temporary storage of the packet during the link layer processing operations. The transaction layer includes a transaction layer engine 24 for processing the TLP 22, and a memory 26, for temporary storage of the TLP 22 during the transaction layer processing operations.

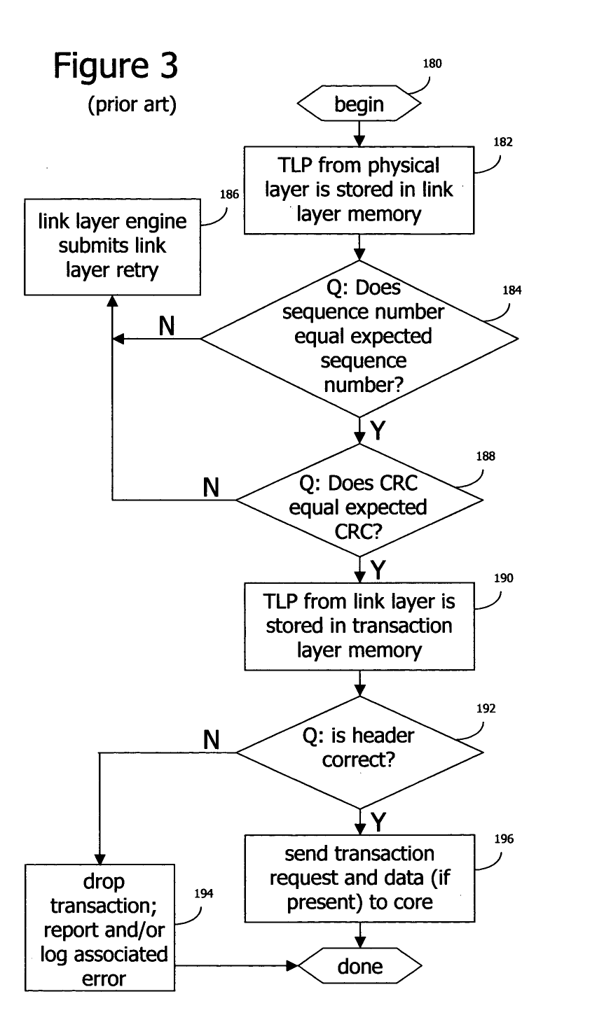

The transaction request 14 is processed as a sequence of distinct operations, as described above. In FIG. 3, a flow diagram illustrates the order in which the operations are processed within both the transaction and link layers, according to the prior art. The TLP 32 is sent from the physical layer 40 and stored in the link layer memory 36 (block 182). The link layer engine 34 processes the TLP 32 by checking the sequence number 56 (block 184) and the CRC 58 (block 188). The sequence number and CRC operations may be reversed. If either test fails, the link layer engine 34 sends a link layer retry (LLR) to the transmitting device (block 186).

CRC is used to detect transmission errors and loss of packets. CRC processing typically involves polynomial or modulo-based mathematics being performed on some portion or the entire packet. The CRC verification may start with the sequence number 56, and include the header 52, the data 54, and the CRC 58. The result produced is compared with an expected result, such as zero. As another possibility, the CRC verification may include the sequence number 56, the header 52, and the data 54, such that the result produced is compared with the CRC 58. In some embodiments, a 32-bit polynomial CRC is calculated over the sequence number 56, the header 52, and the data 54 of the TLP. A myriad of other possibilities for data integrity verification are known. CRC verification can be performed automatically on a serially bitstream as it is being transmitted from one location to another.

Once both the sequence number and the CRC are verified, the link layer engine 34 sends the header and data of the TLP 32 (i.e., the TLP 22) to the memory 26 of the transaction layer 20 (block 190).

Once the TLP 22 is in the memory 26, the transaction layer engine 24 can begin processing the TLP. The transaction layer engine 24 checks the header 52 for pertinent information about the transaction request (block 192). If information in the header is erroneous, the transaction layer drops the transaction and either reports the associated error to the sending device or denotes the error in a transaction log (block 194). Once the header (and CRC) are verified, the engine 24 sends the transaction request (and data 54, if present) to the core 12 of the device 10 (block 196). Thus, the processing of a transaction request within the prior art receiving device of FIG. 2 is complete.

FIGS. 2 and 3 illustrate one prior art arrangement for processing the transaction request at the receiving device. As an alternative, the link layer engine 34 and the transaction layer engine 24 may be combined as a single processing entity, although the processing steps within each layer remain separate. Further, the memory 36 and the memory 26 may be separate or common non-volatile storage. Whatever the arrangement of circuitry, the prior art receiving device 10 fully processes the TLP 32 at the link layer before processing the TLP 22 at the transaction layer may commence. While the link layer 30 is processing the TLP 32, some delay may be incurred. The same is true for the processing at the transaction layer 20. Further, such processing delays may cause bandwidth bottlenecks for subsequent packets, as the packets are sent through the receiving device 10, one after another.

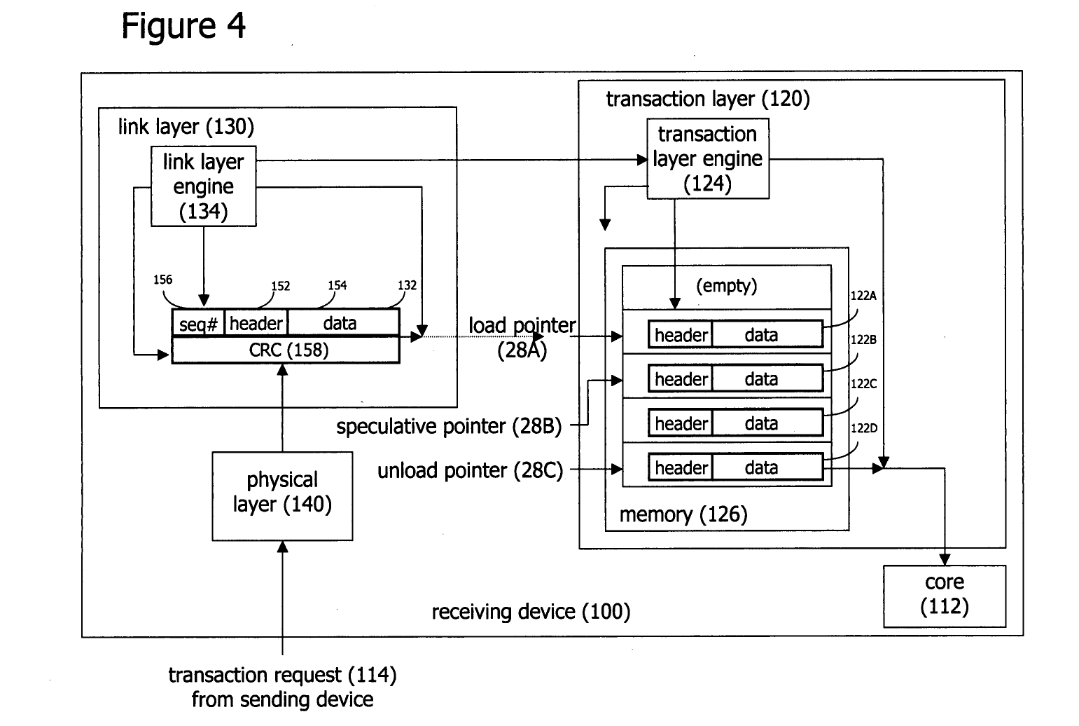

An alternative protocol is illustrated in FIG. 4, according to some embodiments. A receiving device 100 is depicted, in which speculative processing of the packets of a transaction request occurs. The receiving device 100 includes a physical layer 140, for receiving a serially transmitted and packetized transaction request 114 from a sending device, and a core 112, for processing the operation, such as a memory read or write, an I/O read or write, or a configuration request, which is embedded in the packet. Between the physical layer and the core are a link layer 130 and a transaction layer 120 which include circuitry for speculative processing of the packets.

The link layer 130 includes a link layer engine 134 for processing a TLP 132 received from the physical layer 140. The TLP 132 includes a sequence number 156, a header 152, data 154, and a CRC 158. As in the prior art, the link layer engine 134 processes both the sequence number 156 and the CRC 158. However, after processing the sequence number, but before processing the CRC, the link layer engine 134 sends the header 152 and the data 154 portions of the TLP 132 to the transaction layer 120.

The link layer 130 of the receiving device 100 has no memory, as was found in the prior art receiving device (see FIG. 2). Thus, the sequence number 156 is processed immediately upon receipt of the TLP 132. The sequence number 156 is conveniently located at the beginning of the TLP 132, facilitating the immediate processing by the link layer engine 134. Where the sequence number 156 is the expected sequence number, the link layer engine 134 forwards the TLP 122 to the transaction layer 120. Since every packet is assigned a sequence number at the transmitting device, every packet has an expected sequence number that may be verified by the link layer engine 134.

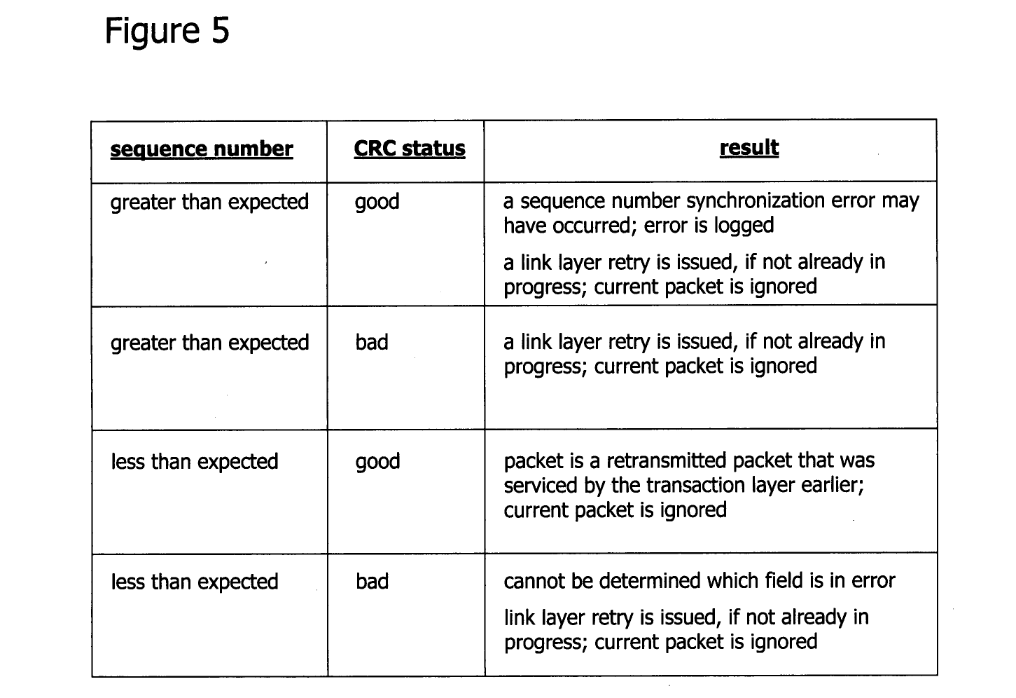

TLPs 132 that are received with a sequence number 156 that does not match the expected sequence number are of no interest to the transaction layer 120. In FIG. 5, a table describes four possible scenarios, comprising all instances when the sequence number 156 of the incoming packet 132 does not match the expected sequence number.

For a given TLP, where the sequence number 156 is greater than expected and the CRC status is good (first table entry), the link layer engine 130 logs an error, to indicate that a sequence number synchronization error may have occurred. A link layer retry is issued by the link layer engine 130, if not already in progress. Thus, the current TLP is ignored by the link layer engine 130 and is not forwarded to the transaction layer. Where the sequence number 156 is greater than expected, but the CRC status is bad (second table entry), a link layer retry is issued by the link layer engine 130 (in response to the bad CRC), if not already in progress, and the current TLP is ignored.

Where the sequence number 156 is less than the expected sequence number, the TLP is also ignored. When the CRC is good (third table entry), the current TLP is a retransmitted packet that was already serviced by the transaction layer. Thus, the current TLP may be ignored. When the CRC is bad (fourth table entry), it cannot be determined which field of the packet is in error (since both the sequence number and the CRC are bad). The link layer engine 130 issues a link layer retry, if not already in progress. Again, the current TLP is ignored.

Thus, the packets that are of interest to the transaction layer 120 are the ones for which the sequence number 156 matches the expected sequence number. This allows the link layer engine 130 to process the sequence number alone and send the header 152 and the data 154 of the TLP 132 to the transaction layer 120, once the sequence number is confirmed as correct.

Since the TLP 132 is transmitted serially to the link layer 130 from the physical layer 140, the link layer engine 134 receives the sequence number 156 as the first bit of the packet. Although confirmation of the sequence number 156 is made at this time, the link layer engine 134 is also beginning to process the CRC 158.

CRC protection typically adds latency because the packet is not considered useful downstream until the CRC is validated. Whatever the validation method, CRC verification may be performed on the incoming serial bitstream without storing the packet contents in memory. Upon receiving the first bit of the packet, the link layer engine 134 verifies the sequence number 156 and consequently routes the bits (i.e., the header and data fields) to storage 126 in the transaction layer 120, performing the CRC verification on the bits of the packet 132 as they pass from the physical layer, through the link layer (without being stored), to the transaction layer.

At the transaction layer, a transaction layer engine 134 performs pre-processing of the TLP 122, which includes the header 152 and the data 154 that was speculatively transmitted by the link layer engine 134. The transaction layer engine 124 ensures that the transaction request 114 is not globally visible (i.e., available to the core) until validated by the link layer engine 134. The memory 126 within the transaction layer 120, however, stores both speculatively transmitted packets and verified packets simultaneously. Thus, pointers are used to distinguish between the packets having different status, which are stored in the same memory.

For illustration, the memory 126 of FIG. 4 depicts a TLP 122A, a TLP 122B, a TLP 122C, and a TLP 122D (collectively, TLPs 122). The TLPs 122A and 122B are recently stored TLPs, in which the link layer engine 134 has not performed CRC verification. The TLP 122C is a TLP in which the CRC verification from the link layer engine is complete, but processing by the transaction layer engine 124 is incomplete. The TLP 122D is one in which has been fully processed in the link layer and the transaction layer and, thus, is ready for transmission to the core 112.

The transaction layer engine 124 uses a load pointer 28A, a speculative pointer 28B, and an unload pointer 28C (collectively, pointers 28) to keep track of the status of the TLPs 122 within the memory 126. The load pointer 28A points to the address where the current TLP 122A is speculatively stored. Any new packets sent by the link layer engine are stored at the address pointed to by the load pointer. The unload pointer 28C points to the address where TLPs which are ready for transmission to the core 112 are stored. The TLP 122C has both been “released” by the link layer engine 134, having passed CRC verification, and by the transaction layer engine 124, having been processed there as well.

Between the load pointer 28A and the unload pointer 28C, the speculative pointer 28B essentially floats, pointing to intermediate address locations of the memory 126. The position of the speculative pointer 28B is governed by whether the link layer engine 134 has confirmed the validity of the speculatively forwarded TLP or not to the transaction layer engine 124.

Take the TLP 122B, for example. In FIG. 4, the speculative pointer 28B is pointing to the address in which the TLP 122B is stored. If the CRC of the TLP 122B is deemed good by the link layer engine 134, the transaction layer engine 124 is notified, and the speculative pointer 28B is moved “up” one address location, in a direction toward the load pointer 28A. This has the effect of ensuring that subsequently loaded TLPs do not get written over the TLP 122B.

If, instead, the CRC of the TLP 122B is determined to be bad by the link layer engine 134, the transaction layer engine 124 is notified and the load pointer 28A is moved “down” one address location, in a direction towards the speculative pointer 28B. The effect of this downward movement of the load pointer 28A is to cause a subsequently loaded TLP to be written over the TLP 122B. This is an appropriate result, since the TLP 122B failed the CRC validation.

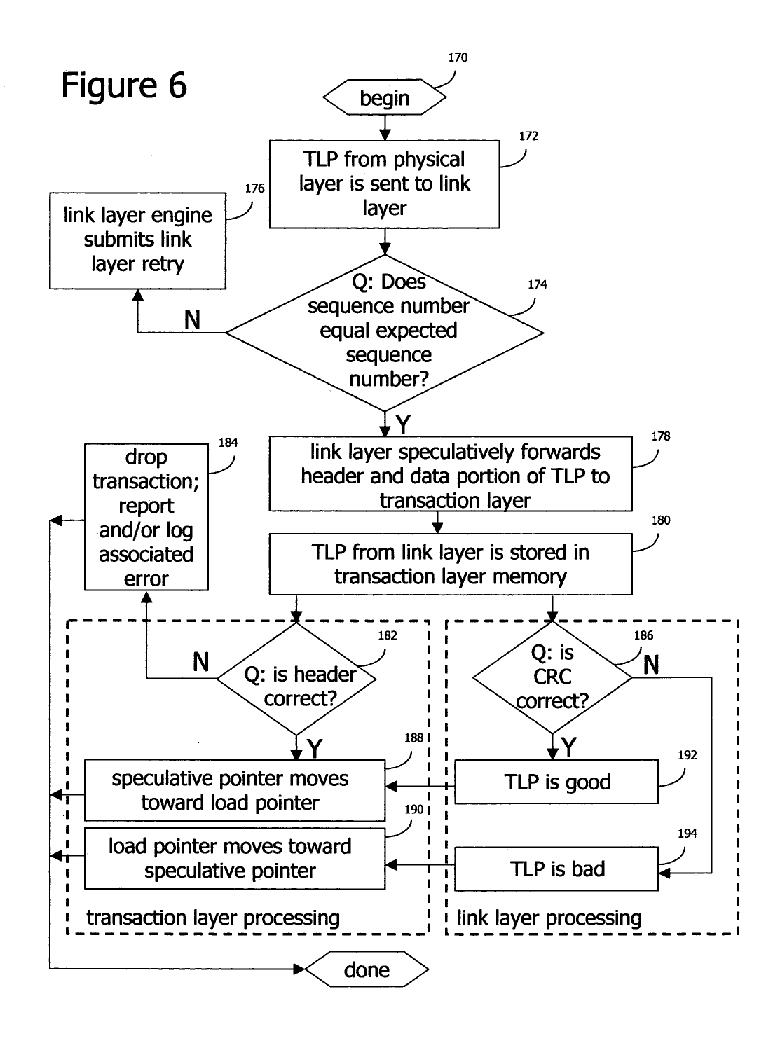

A flow diagram in FIG. 6 illustrates how speculatively forwarded transaction requests may be simultaneously processed by the link layer and the transaction layer. The receiving device 100 of FIG. 4 is used to illustrate the method, which begins when the TLP 132 (containing the transaction request 114 from a sending device) is sent from the physical layer 140 to the link layer 130 (block 172). In contrast to the prior art receiving device (see FIG. 3), the TLP 132 is not stored in link layer memory, but is immediately processed. The link layer engine 134 compares the sequence number 156 of the TLP with an expected sequence number (block 174). If the sequence number is not the expected sequence number, the link layer engine sends a link layer retry to the sending device (block 176).

If, however, the sequence number matches the expected sequence number, the link layer engine 134 speculatively forwards the header 152 and the data 154 of the TLP 132 to the transaction layer (block 176). The forwarded TLP 122 is stored in the memory 126 of the transaction layer 120 (block 180). At this point, both the link layer and the transaction layer may simultaneously process part of the transaction request 114. At the transaction layer 120, the transaction layer engine 124 is checking the header of the TLP for information about the transaction (block 182). If the header is incorrect, such as when the header information is inconsistent with the type of transaction being sent, the transaction layer engine 124 drops the transaction and either reports the associated error or records the error in a transaction log (block 184). Otherwise, the header is considered correct. Once the header and CRC are verified, the transaction layer engine 124 is unable to forward the transaction request to the core 112, until the request is “released” by the link layer engine 134.

Meanwhile, the link layer engine 134 is processing the CRC of the TLP 132, after having forwarded part of the TLP to the transaction layer (block 186). If the CRC is not correct, the link layer engine 134 will notify the transaction layer engine 124 that the TLP is bad (block 194). The transaction layer engine will change the location of the load pointer 28A, moving it toward the speculative pointer 28B (block 190). This has the effect of causing subsequent packets to overwrite the current TLP. If the CRC is correct, the link layer engine will so notify the transaction layer engine (block 192). In response, the transaction layer engine 124 changes the location of the speculative pointer 28B, moving it toward the load pointer 28A (block 188). This ensures that subsequent packets will not be written over the current packet. TLPs that complete verification are sent to the core 112.

The receiving device 100 (FIG. 4) and method for speculatively processing packets (FIG. 6) are advantageous over the prior art for several reasons. The streaming of TLP bits through the link layer eliminates the need for storage within the link layer. Further, the number of cases in which packet validation is performed is also reduced, since only packets that match the expected sequence number are forwarded to the transaction layer. Finally, the transaction layer does not receive any duplicate packets during replay, or link level retry.

While the invention has been described with respect to a limited number of embodiments, those skilled in the art will appreciate numerous modifications and variations therefrom. It is intended that the appended claims cover all such modifications and variations as fall within the true spirit and scope of the invention.

1. A receiving device, comprising:
a link layer for processing a link layer packet, the link layer packet comprising fields for a sequence number, a transaction layer packet, and a data integrity code; and
a transaction layer for processing the transaction layer packet;
wherein the link layer forwards the transaction layer packet to the transaction layer as a speculative transaction layer packet if the sequence number of the link layer packet is equal to an expected sequence number, and after checking the data integrity code, notifies the transaction layer that the speculative transaction layer packet is either good or bad.

2. The receiving device of claim 1, wherein the link layer verifies the data integrity code and notifies the transaction layer that the speculative transaction layer packet is good.

3. The receiving device of claim 2, wherein the link layer fails to verify the data integrity code and notifies the transaction layer that the speculative transaction layer packet is bad.

4. The receiving device of claim 1, wherein the data integrity code is a cyclic redundancy check.

5. The receiving device of claim 1, further comprising:
a physical layer for receiving a transaction request from a sending device, wherein the transaction layer packet includes the transaction request.

6. The receiving device of claim 5, further comprising:
a link between the receiving device and the sending device.

7. The receiving device of claim 6, further comprising:
a core for receiving the transaction layer packet from the transaction layer once the transaction layer packet is deemed good.

8. The receiving device of claim 1, wherein the transaction layer further comprises:
a memory for storing a plurality of transaction layer requests, the memory comprising a plurality of individually addressable and sequential locations, the locations being tracked by a load pointer and a speculative pointer, wherein the speculative transaction layer packet is stored in a memory location pointed to by the load pointer.

9. The receiving device of claim 8, wherein the speculative pointer is moved to a location of the load pointer when the data integrity code of the speculative transaction layer packet is deemed good.

10. The receiving device of claim 8, wherein the load pointer is moved to a location of the speculative pointer when the data integrity code of the speculative transaction layer packet is deemed bad.

11. A method for processing a packet by a link layer of a receiving device, comprising:
receiving a packet by a link layer engine, the packet comprising a sequence number, a header, data, and a data integrity code, wherein the packet is not stored in a memory;
forwarding the packet to a transaction layer engine if the sequence number equals an expected sequence number;
checking the data integrity code of the packet to produce a result; and
notifying the transaction layer engine of the result.

12. The method of claim 11, further comprising:
receiving the packet from a physical layer of the receiving device.

13. A method for processing a packet by a transaction layer of a receiving device, comprising:
receiving the packet from a link layer engine, the packet comprising a sequence number, a header, data, and a data integrity code, wherein the sequence number is equal to an expected sequence number but the data integrity code is not verified;
storing the packet in a memory for processing; and
not forwarding the packet to a core of the receiving device until receiving confirmation from the link layer engine that the data integrity code is correct.

14. The method of claim 13, further comprising:
being notified by the link layer engine that the data integrity code is not correct; and
storing a subsequent packet in the memory such that the packet is overwritten.

15. The method of claim 13, further comprising:
being notified by the link layer engine that the data integrity code is correct; and
storing a subsequent packet in the memory such that the packet is not overwritten.

16. A receiving device, comprising:
a link layer for receiving a packet from a physical layer, the packet comprising a sequence number, a header, and a data integrity code, the link layer including no memory;
a transaction layer comprising a memory for storing a plurality of packets; wherein the link layer speculatively forwards the packet to the transaction layer when the sequence number of the packet matches an expected sequence number, the transaction layer stores the packet in memory and processes the header, but does not forward the packet to a core of the receiving device until the link layer has confirmed the data integrity code as correct.

17. The receiving device of claim 16, wherein the memory of the transaction layer is addressable using a load pointer or a speculative pointer, each pointer pointing to an address of the memory.

18. The receiving device of claim 17, wherein the speculative pointer is moved to the load pointer address when the data integrity code is correct.

19. The receiving device of claim 17, wherein the load pointer is moved to the speculative pointer address when the data integrity code is incorrect.

20. The receiving device of claim 16, wherein the data integrity code is a cyclic redundancy check.

21. The receiving device of claim 17, wherein the memory of the transaction layer is further addressable using an unload pointer, wherein the unload pointer points to addresses storing transaction layer packets which may be sent to the core of the receiving device.
